(19) United States
(12) Patent Application Publication
(10) Pub. No.: US 2002/0190426 A1
(43) Pub. Date: Dec. 19, 2002

(54) Static dissipative mold release agent and use in casting and molding processes

(76) Inventors: Nathan M. Seidner, North Ogden, UT (US); Joh L. Rackham, Perry, UT (US)

Correspondence Address: SULLIVAN LAW GROUP, 1850 NORTH CENTRAL AVENUE, SUITE 1140, PHOENIX, AZ, 85004, US

(21) Appl. No.: 10/066,942

(22) Filed: Feb. 4, 2002

Related U.S. Application Data
(60) Provisional application No. 60/267,961, filed on Feb. 9, 2001.

(51) Int. Cl. B28B 7/36; B29C 33/64

(52) U.S. Cl. 264/219; 264/105; 264/338; 106/38.22; 249/115

(57) ABSTRACT

A silicone-epoxy resin is mixed with a conductivity enhancing agent, such as carbon black, and is cured to control the resistivity of films that may be used as mold release agents in mold processing or mold shaping electrically sensitive energetic compositions, such as rocket fuels, explosives, gas generator fuels and the like. The uncured precursor to the mold release agent is placed as a coating on molds that are used in these processes. Upon curing on the mold, the enhanced conductivity of the film permits dissipation of static electricity from the electrically sensitive energetic compositions.

### RELATED APPLICATION

This application claims the benefit of priority of U.S. provisional patent application No. 60/267,961 filed in the U.S. Patent & Trademark Office on Feb. 9, 2001, the complete disclosure of which is incorporated herein by reference.

### BACKGROUND OF THE INVENTION

1. Field of the Invention

The present invention relates to mold tooling and associated mold release agents for use in casting processes used to form or shape materials that are sensitive to electrical currents or charges. Examples of the sensitive materials which are contemplated for use with the present invention include combustible materials, such as solid rocket propellants and gas generator fuels, as well as explosive materials, such as shaped charges, pelletized gunpowder, and the like.

2. Description of Related Art

Molded energetic compositions, such as solid rocket propellants, shaped charges, pelletized explosives, and the like, are normally cast through the use of metal molds that are coated with tetrafluoroethylene polymers, e.g., Teflon® polymers. These polymers are used because they are compatible with the energetic compositions, do not contaminate the energetic compositions, and prevent the energetic compositions from sticking to the mold. However, the mold release polymers have relatively high resistivities that hinder the polymers from dissipating or conducting electricity away from the energetic compositions during shaping processes. Thus, in the particular case of solid rocket propellants, the volume of propellant being molded can be quite large, and appreciable quantities of static electricity need to be eliminated to avert potential disaster.

Numerous problems arise from the use of conventional Teflon® coatings as mold release agents. The coatings eventually wear off of the mold, which must then be treated a second time or remanufactured. The cost of building a metal mold and coating it with Teflon® can exceed several hundred thousand dollars, and the commercial order may not be completed for a year or more. Furthermore, the formation of Teflon coatings requires the use of relatively high temperatures that make impractical the use of Teflon® on many substrates including foam, most plastics, and wood.

Other known mold release agents have compatibility problems when used in combination with propellants. For example, traditional abherents including dry powders of silicates or diatomaceous earth, suspensions such as bentonite and water, solutions such as soap and water, or soft solids such as waxes, all tend to contaminate the propellant body and impart deleterious effects upon the propellant performance. A solid mold release agent is needed that does not contaminate the propellant.

Solid materials, other than Teflon®, that can potentially be used as mold release agents either do not dissipate electricity in a sufficient manner for use as propellant mold coatings or lack sufficient resistance for bonding with the propellant. Examples of these mold release agents, which are usually applied as polymer coatings, include the coatings described in Law et al. U.S. Pat. No. 4,113,665, which teaches the use of a silicone resin and a trialkoxy silane reacted with a polyol. The coatings provide useful corrosion resistance, but the surface energy of these coatings is too high for use as an effective mold release agent with materials sensitive to electrical current or charges.

Riddle, U.S. Pat. No. 5,039,745, describes a graffiti resistant coating including a mixture of silicone resin, tetrafluoroethylene resin, and polyurethane. This polymer is reported to have a greater surface energy than 60 lbs/in², which means that the polymer is likely to stick to molded propellants.

U.S. Pat. No. 6,084,020 to Smith et al. teaches the use of a composition including two coatings. The first or primary coating contains copolymers, graft copolymers, or block copolymers that are made of resins having non-stick characteristics upon curing, including polyvinylfluoride, silicone, and polytetrafluoroethylene resins, in combination with resins having hardness and adhesion properties upon curing, including epoxy, alkyd, and polyurethane resins. These resins are mixed to impart a surface energy ranging from 22 to 28 dynes/cm². A second coating or topcoat is a silicone polymer, especially poly(alkyl)siloxanes including such functional groups as hydroxyl, alkyl, siloxyl, amino, carboxyl, halo and the like. An interdigitating compound is mixed into the top coat to facilitate adhesion between the two coats, and includes carboxylates, phosphate esters, alkyl ether phosphates, sulfate esters, sulfated monoglycerides, sulfonates of unsaturated acids, sulfosuccinates, and ethoxylated alcohols.

Other non-stick coatings include commercially available products such as WEARLON®, which is a water-based graft silicone epoxy copolymer capable of adhering to plastics, paper, textiles, packaging, and metal over a wide temperature range.

The foregoing polymer coatings are non-conductive coatings that should not be used as mold release agents for shaping electrically sensitive materials, such as propellants, because the coatings lack a sufficient capacity to dissipate electricity. Experience in the propellant molding industry provides a classification system according to the following definitions:

Non-conductive—having a surface resistivity greater than 1.0×10¹² ohms/in² (0.155×10¹² ohms/cm²),

Static dissipative—having a surface resistivity in a range of 1.0×10⁶ ohms/in² (0.155×10⁶ ohms/cm²) to 1.0×10¹² ohms/in² (0.155×10¹² ohms/cm²), and

Conductive—having a surface resistivity less than 1.0×10⁶ ohms/in² (0.155×10⁶ ohms/cm²).

Materials that are used as mold release coatings for use in shaping propellants should at least be static dissipative and are preferably conductive. None of the foregoing materials meet these requirements when applied to mold surfaces in sufficient thickness, e.g., three to four mils, for use as a mold release agent.

### OBJECTS OF THE INVENTION

Accordingly, an object of the present invention is to provide a mold release agent precursor for use in combination with tooling for the shaping, casting, or handling of electrically sensitive materials.

Another object of the invention is to provide a durable mold release agent having an ability to dissipate or conduct electricity.

Another object of the invention is to provide a mold release agent having suitable release properties for use in combination with combustible materials, such as solid propellants, fuels, explosives, and the like, as well as other materials having similar adhesion properties and methods that achieve these objects.

Another object of the invention is to provide a coated mold assembly and related apparatus and methods that achieve the foregoing objects with relative cost effectiveness.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

A durable polymer mold release agent together with associated apparatus and methodology are provided to achieve the foregoing objects, in accordance with the purposes of the invention as embodied and broadly described in this document.

A mold release agent according to the invention broadly is formed from a precursor composition including, at least, a conductivity enhancing agent that is mixed with a polymer resin in effective amounts to impart, upon curing of the polymer resin, a surface resistivity less than 1×10¹² ohms/in². The polymer is preferably formed as a film having a thickness of at least 0.0762 mm (three mils) to 0.254 mm (ten mils).

The polymer may be any polymer having non-stick characteristics upon curing, such as described in U.S. Pat. No. 6,084,020 including copolymers, graft copolymers, or block copolymers. For example, U.S. Pat. No. 6,084,020 describes coatings prepared from a blend or copolymer formed of (a) a polymeric or pre-polymeric materials for imparting hydrophobic, lubricous and non-stick characteristics, such as polyvinylfluoride, silicone, polyfluoropolymeric materials (e.g., polytetrafluoroethylene), or combinations thereof, and (b) a polymeric or pre-polymeric material for imparting hardness and adhesion properties, including epoxy, alkyd, and polyurethane resins, and combinations thereof. The description of these primary blends or copolymers is incorporated by reference from U.S. Pat. No. 6,084,020. These resins (a) and (b) may be mixed to impart a surface energy ranging from 22 to 28 dynes/cm². A particularly preferred polymer is a silicone epoxy resin, such as the water-based three component grafted silicone epoxy resins that are sold as the WEARLON product line available from Decora, Inc. and Eccotech.

The silicone-epoxy resin can be a mixture of silicone and epoxy resins, or a copolymer including silicone and epoxy functional groups. The silicone-epoxy resin is preferably a water-based three component grafted silicone epoxy resin, such as the WEARLON® products available from Decora, Inc. and Eccotech, Inc, both of Fort Edward, N.Y. These products contain relative amounts of silicone and epoxy components that are grafted in a manner known in the prior art to impart, upon curing, non-stick characteristics and low adhesion through adjustment of the amount of the silicone component in combination with the high strength/high adhesion epoxy component. The silicone resin and the epoxy resin are preferably mixed in a ratio ranging from 1:4 to 4:1 parts of silicone resin to epoxy resin by weight.

The conductivity-enhancing agent can be any material having a lower resistivity than the silicone-epoxy resin. For example, the conductivity-enhancing agent may be ionic in nature, such as ammonium ions or carbocations, or a material that is capable of generating a photoinitiated free-radical, such as nitrobenzaldehyde. Carbon particles are especially preferred for use as the conductivity enhancing agent, which may be charcoal or graphite and is more preferably a conductive form of carbon black, such as the furnace-formed carbon black pellets that can be obtained commercially as Cabot® Black Pearls 2000. Not all carbon black products are conductive, and many commercially available forms of carbon black, other than furnace-formed carbon black in the nature of Cabot® Black Pearls, are non-conductive. Accordingly, other agents may be added to the carbon black to enhance conductivity. These other agents include conductive metal fines, e.g., the transition metals, iron, aluminum, or copper, salts of conductive metals, heavy metal soaps, and ionic conductivity enhancing agents.

It has been discovered that use of the conductivity enhancing agent, such as carbon particles, in a mixture with the silicone-epoxy resin does not substantially diminish the structural properties of the cured resin when the carbon particles are used in amounts up to about ten percent. These structural properties may be measured by standardized testing procedures. For example, it is preferably the case that the cured silicone epoxy resin and carbon particle mixture impart a non-stick release adhesion of less than about 20 g/in determined by TAPPI 502; an ultimate contact angle (water) of 85 degrees to 99 degrees determined by goniometer; and a pencil hardness of up to 2H to 3H (scratch) and up to 3H to 4H (gouge) determined by ASTM D3363. The TAPPI 502 and ASTM D3363 standards are hereby incorporated by reference to the same extent as though fully disclosed herein. The mold release agents described herein all have non-stick characteristics, which are hereby defined to have a release adhesion of less than 50 g/in determined by TAPPI 502. The release adhesion is more preferably less than 40 g/in, even more preferably less than 30 g/in, and most preferably less than 20 g/in as determined by TAPPI 502.

The mold release agent typically becomes static dissipative when the conductive carbon particles, especially conductive forms of carbon black, are present in the silicone epoxy resin in an amount greater than two percent by weight. The static dissipative properties are improved at a carbon black content of at least three percent by weight. The most preferred range of conductive carbon black content is from three percent to seven percent by weight. Generally, these ranges impart a static dissipative conductivity or surface resistivity to the mold release agent in the range from 1.0×10⁶ ohms/in² to 1.0×10¹² ohms/in². In other applications, even more of the conductivity enhancing agent may be added up to ten percent or more by weight to impart a surface resistivity that is characterized in the conductive range of less than 1.0×10⁶ ohms/in².

The mold release agent may be applied to the surface of a mold by spraying, misting, melting, chemical vapor, dip coating, washing, painting, screening, and any other means of application. A particularly advantageous feature of the silicone-epoxy resins is that solution viscosity may be adjusted by the addition of a compatible solvent, e.g., a nontoxic solvent such as water in the case of a water-based resin, prior to curing of the resin to facilitate spray coating of the mold release agent. The resultant mold, upon curing of the mold release agent, has a contact surface that is coated with the mold release agent having properties as described above, and may be used in a process of shaping materials, such as electrically sensitive materials.

In the process of making the mold release agent, high speed shear blending or mixing is especially advantageous in the process of making the mold release agent where the solvent, conductivity enhancing agent, and any diluents, such as bentonite or mica pigments, are preferably blended to form a homogenous dispersion in the resin. The use of a homogenous dispersion obtained through high shear mixing in this process increases the uniformity and repeatability in performance of the resultant mold release agent.

### BRIEF DESCRIPTION OF THE DRAWINGS

The accompanying drawings, which are incorporated in and constitute a part of the specification, illustrate presently preferred embodiments and methods of the invention and, together with the general description given above and the detailed description of the preferred embodiments and methods given below, serve to explain the principles of the invention.

FIG. 1 is a comparison plot of volume resistivities among various types of carbon black;

FIG. 2 is a midsectional view of a mold component for use in forming a conically shaped body, such as a shaped charge or fuel for a rocket motor, where the mold is depicted in a process of being coated with a mold release agent;

FIG. 3 depicts an assembly view of a complete mold assembly including the midsectionally represented mold component that is shown in FIG. 2;

FIG. 4 depicts the complete mold assembly of FIG. 3 in a process of conformably shaping contents in the mold; and

FIG. 5 depicts a midsectional view of another mold embodiment in use to shape an energetic composition, i.e., a solid rocket fuel, within a rocket motor segment.

### DESCRIPTION OF THE PREFERRED EMBODIMENTS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

In accordance with one aspect of the invention, a mold release agent is prepared to include a conductivity-enhancing agent dispersed in a silicone epoxy resin. The conductivity enhancing agent and the silicone epoxy resin are present in effective amounts to impart a surface resistivity of less than 1×10¹² ohms/in² upon curing of the silicone epoxy resin, and the mixture may be made-ready for spray coating by the addition of a solvent. Example 1 below provides, by way of example, nonlimiting methods and materials for practicing this aspect of the invention.

### EXAMPLE 1

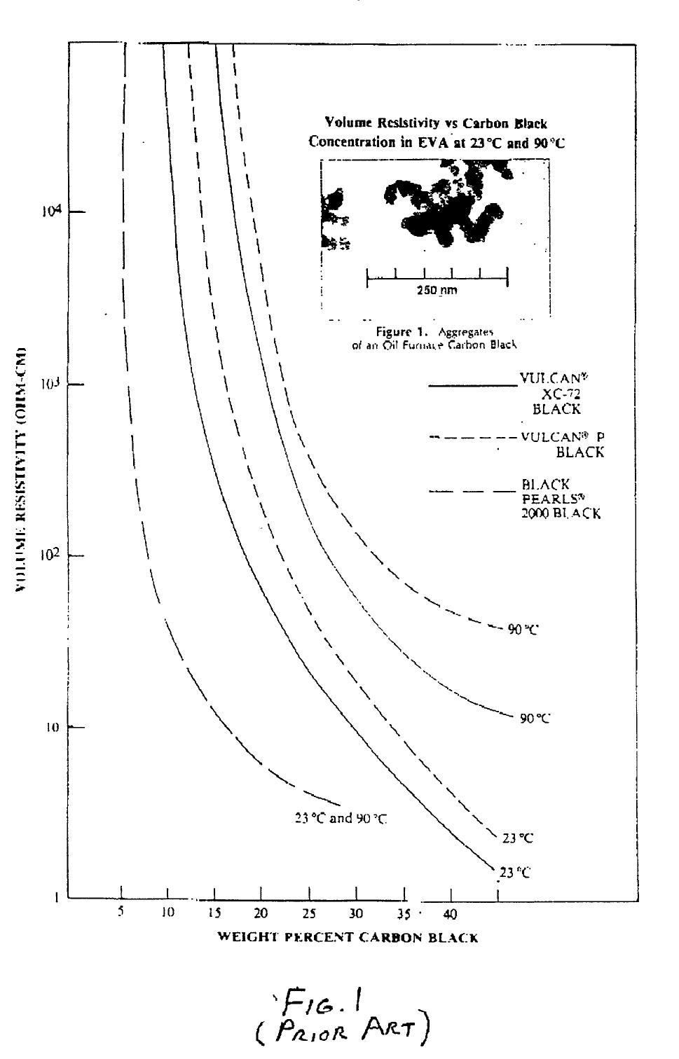

A commercially available water based graft silicone epoxy copolymer resin, WEARLON® 4545-76, was purchased on commercial order from Decora, Incorporated of Fort Edward, N.Y. In like manner, a commercially available form of carbon black, Black Pearls 2000, a furnace-formed variety of carbon-black, was purchased Cabot Corp. of Boston, Mass. The Black Pearls 2000 variety of carbon black is formed by a technique using an oil-furnace and, consequently, is highly structured from aggregates to present a large surface area. FIG. 1 shows a manufacturer's comparison of volume resistivities between three types of carbon black mixed in ethylene vinyl acetate copolymer (an adhesion polymer) where the resistivity of Black Pearls 2000 shows essentially no temperature dependency in the range from 23° C. to 90° C. The comparison shows that Black Pearls 2000 is the least resistive of all carbon blacks that were tested. This low resistivity and low temperature dependency is associated with a high surface area that is in the range of about 1500 m²/g, and compares favorably to the other carbon blacks which have surface areas in the range from 25 to 560 m²/g.

The WEARLON® 4545-76 resin was provided from the manufacturer on special commercial order without any filler materials including, e.g., mica and clay pigments. Five aliquots of the resin filtrate were mixed with various weight percentages, i.e., included 3%, 4%, 5% and 7%, of carbon black using a conventional high speed shear blender, namely, a TUROX mixer at 15,000 rpm for about one minute until the samples appeared to the eye as a uniform dispersion of carbon black in the resin.

In the case of the 5% and 7% samples, the mixture tended to form a paste due to thickening with the addition of carbon black, so potable tap water from the Thiokol Propulsion facility proximate Brigham City, Utah, was added in an amount of about five percent by weight to reduce the mixture viscosity to a fluid state. Mixing time was increased to two minutes for the 7% sample.

The mixtures were spray-coated onto fiber glass plates and dried to cure the resin in a hardened or polymerized film about 3-10 mils thick. Surface resistivity measurements were performed on each sample using a Keithley Model 6501 resistivity cell. Table 1 below summarizes the surface resistivity measurement results.

TABLE 1

| Carbon Black | | |
|---|---|---|
| Content | Surface Resistivity | |
| (Weight Percent) | (Ohms/in²) | Comments |
| 3 | 4.17 × 10¹⁰ | Static dissipative |
| 4 | 1.79 × 10⁸ | Static dissipative |
| 5 | 2.55 × 10⁶ | Very static dissipative |
| 7 | 3.87 × 10⁵ | Conductive |

In accordance with another aspect of the invention, a mold release agent is again prepared to include a conductivity enhancing agent dispersed in a silicone epoxy resin with emphasis upon results obtained from different mixing process conditions. The manner of mixing is varied by the amount of water solvent added to thin the mixture and by the amount of mixing time in the high shear blender. Again, the conductivity enhancing agent and the silicone epoxy resin are present in effective amounts to impart a surface resistivity of less than 1×10¹² ohms/in² upon curing of the silicone epoxy resin. Example 2 below provides, by way of example, nonlimiting methods and terials for practicing this aspect of the invention.

### EXAMPLE 2

A commercially available water based graft silicone epoxy copolymer resin, WEARLON® 4545-76 was purchased on commercial order from Decora, Incorporated of Fort Edward, New York. In like manner, a commercially available form of carbon black, Black Pearls, a furnace-formed variety of carbon-black, was purchased Cabot Corp. of Boston, Mass.

The WEARLON® 4545-76 resin was purchased on a special commercial order that was prepared by the manufacturer without any filler materials including, e.g., mica and clay pigments. Eight aliquots of the resin were mixed with various weight percentages, i.e., 2.5%, 2.5%, 3%, 3%, 4%, 3%, 3%, and 3%, carbon black using a conventional high speed shear blender, namely, a TUROX mixer at 20,500 rpm. Three percent water by weight was added to decrease the viscosity of the 4% sample.

The mixtures were spray-coated onto metal plates and dried to cure the resin in a hardened or polymerized film about 3-10 mils thick. Surface resistivity measurements were performed on each cured sample using a Keithley Model 6501 resistivity cell. Table 2 below summarizes the surface resistivity measurement results.

TABLE 2

| Carbon Black | | |
|---|---|---|
| Content | Surface Resisitivy | |
| (Weight Percent) | (Ohms/in²) | Comments |
| 2.5 | 1.09 × 10¹⁰ | Mixed for 3 minutes; Static |
| | | dissipative |
| 2.5 | 3.10 × 10⁹ | Mixed for 3 minutes; 3 percent |
| | | water by weight added after |
| | | initial mixing with additional 30 |
| | | seconds mixing and prior to |
| | | spraying; Static dissipative |
| 3 | 1.19 × 10⁹ | Mixed for 1.75 minutes total |
| | | including 30 second blend then |
| | | scrape; Static dissipative |
| 3 | 7.87 × 10⁸ | Mixed for 1.75 minutes total |
| | | including 30 second blend then |
| | | scrape; 3 percent water by |
| | | weight added after initial mixing |
| | | with additional 30 seconds |
| | | mixing and prior to spraying; |
| | | Static dissipative |
| 4 | 1.30 × 10⁷ | Mixed for 4 minutes total |
| | | including 30 second blend then |
| | | scrape; 3 percent water by |
| | | weight added after initial mixing |
| | | with additional 30 seconds |
| | | mixing and prior to spraying; |
| | | Static dissipative |
| 3 | 1.23 × 10¹¹ | Mixed for 2.5 minutes total |
| | | including 30 second blend then |
| | | scrape; Static dissipative |
| 3 | 5.06 × 10⁷ | Mixed for 3.5 minutes total |
| | | including 30 second blend then |
| | | scrape; Static dissipative |
| 3 | 1.11 × 10⁷ | Mixed for 4.5 minutes total |
| | | including 30 second blend then |
| | | scrape; Static dissipative |

The foregoing results show that the process conditions and the carbon content both act in combination to alter the surface resistivity. For example, increasing the blending time from 2.5 minutes to 3.5 minutes for the 3% carbon black samples caused a corresponding decrease in surface resistivity from 1.23×10¹¹ to 5.06×10⁷ ohms/in², but additional mixing time (to a total of 4.5 minutes) caused a further decrease in surface resistivity down to only 1.11×107 10⁷ ohms/in². These results show that a surprisingly high amount of high shear additional mixing time is required to provide a homogenous dispersion of the conductive carbon black particles throughout the resin and, consequently, it is believed that sufficient mixing time to provide a homogenous dispersion will be required to establish uniform repeatability in commercial process operations. The additional mixing time may also modify the internal solution chemistry to achieve this effect.

In like manner, even though the resins are dried to cure the resin in a hardened polymerized form, the addition of water can have significant effects upon the surface resistivity of the hardened polymerized form. A comparison between the 2.5% and 3% samples shows that the addition of water whether prior to blending or prior to spraying can result in an approximate order of magnitude drop in surface resistivity, e.g., as from 1.09×10¹⁰ to 3.10×10⁹ 10⁷ ohms/in² for the 2.5% samples. The addition of water facilitates the creation of a homogenous dispersion of conductivity enhancing agent in the resin through mixing, and may also alter the internal chemistry of the resin to achieve these observed effects.

This example illustrates that various silicone epoxy resins may be subjected to similar process sensitivity tests regarding mixing conditions and the addition of solvents to obtain empirical results that are tailored to impart a selected surface resistivity in a particular resin.

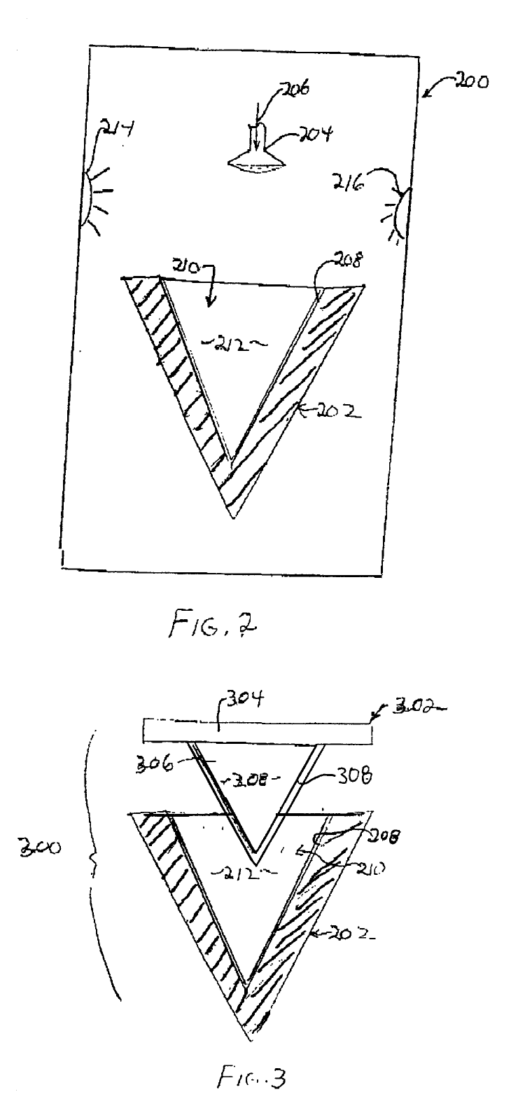

Yet another aspect of the invention involves a method of applying the mold release agent to a mold. As shown by way of example in FIG. 2, a deposition chamber 200 contains a conical mold 202 segment, which in FIG. 2 is shown in a midsectional elevational view. Prior to application of mold release agent 206, the contact surface 208 of the conical mold 202 is preferably degreased and may be subjected to abrasive preparation. A spray misting nozzle 204 directs a spray or mist of liquid mold release agent 206 towards the contact surface 208 defining an interior mold cavity 210, which is coated with a liquid film 212 of the mold release agent. Energizing elements 214 and 216, e.g., heating or photopolymer ultraviolet initiation sources, are used to facilitate curing of the mold release agent film 212 as the film converts into a hardened state.

Generally, the mold release agent is cured or polymerized according to conventional techniques, such as manufacturer's instructions for curing the resin component. Where curing is initiated by a photopolymerization reaction, for example, the energizing sources may be photoemitters tuned to the desired spectrum for initiating photopolymerization. Where, as in the case of water base silicone resins, curing is performed by drying the resin, the energizing sources can be heating elements or photoheating elements. Alternatively, the mold release agent 106 may be applied by other means including dip-coating, washing, screening, combinations of these techniques, painting or any other means of application.

Yet another aspect of the invention involves the finished mold having a coating of the mold release agent, which may be prepared by the coating process as described above. FIG. 3 shows, by way of example, the midsectional mold segment 202 of FIG. 2 having a cured film 212 of the mold release agent. A complete mold assembly 300 additionally includes a cap 302, which comprises an integrally formed lid plate 304 together with a conical nipple 306 that bears a coating of the mold release agent 308. The mold release agent 308 may be identical to the mold release agent film 212, or the mold release agent 308 may have a different composition to impart different hardness and adhesion physical characteristics to the mold release agent 308, as required to better fulfill the demands of a location on the cap 302 versus the demands that are imposed upon the film 212.

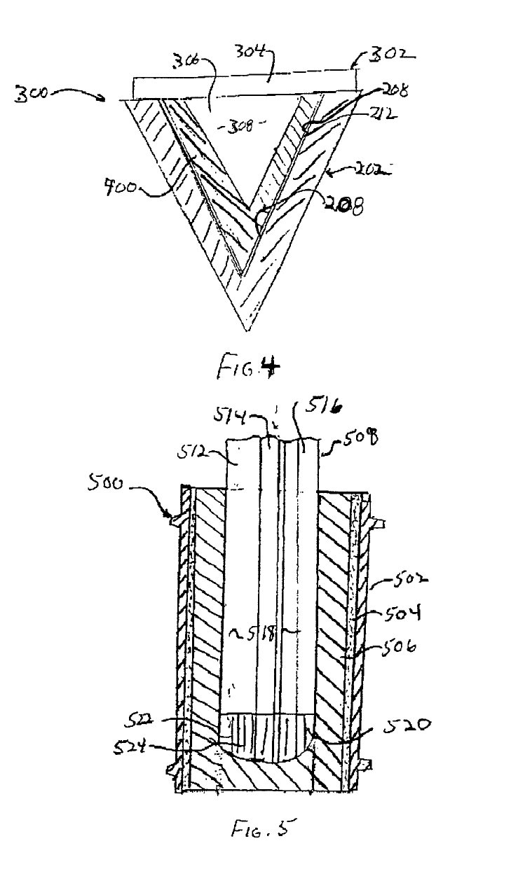

Still another aspect of the invention involves the use of a mold assembly, for example, the mold assembly shown in FIG. 3, in a method of shaping electrically sensitive energetic compositions. As shown in FIG. 4, the mold assembly 300 has been assembled to present the contact surface 208 covered with the mold release agent film 212 as a mechanism to conformably shape the mold contents 400. As shown in FIG. 3, the mold contents 400 may be an explosive in the process of being formed into a hollow conical shaped charge, a gas generator fuel, or other combustible material. The mold contents 400 are placed into the mold cavity 210, e.g., as by pouring a liquid or gel, or by pouring a powder. The mold contents are subsequently hardened into the desired shape by curing the liquid using conventional means, by compressing the powder into the desired shape, or by a combination of these techniques. After hardening of the mold contents 400, the cap 302 is removed, and the mold contents 400 are removed from the mold.

FIG. 5 presents yet another example of a mold assembly that is used in shaping energetic compositions. A conventional solid rocket motor segment 500, e.g., such as may be assembled with other segments and used to boost a rocket or missile into outer space, includes a lightweight alloy outer metal shell 502, a butyl rubber liner 504 to protect the outer metal shell 502, and an interior fuel core 506 including a conventional energetic fuel composition that is made of fine aluminum powder, perchlorate, and a polymeric binder. The energetic composition 506 may be any type of solid rocket fuel and is initially mixed to form a gel or liquid, which is slowly poured into the interior of the rocket motor segment prior to hardening of the polymeric binder.

A mold 508 includes a plurality of wings 512, 514, and 516, that are used to shape the energetic composition 506 as it hardens from a liquid to a solid state. The wings 512, 514, and 516 form a star-shaped cavity that is filled by the mold 508 as depicted in FIG. 5. The contact surface of mold 508 is covered with a mold release agent 518 as described above to facilitate withdrawal of the mold 508 once the energetic composition 506 has hardened sufficiently to permit withdrawal. It is noted that the head section 520 of mold 508 may be provided with many additional fins, e.g. fins 522 and 524, to provide a star shape having more surface area than the surface area that is formed using the wings 512, 514, and 516 alone.

Those skilled in the art will appreciate that the foregoing embodiments and aspects of the invention are intended for purposes of illustrating preferred embodiments and are not intended to limit the underlying concepts. For example, the mold contents 300 and the mold assembly 200 may be used in any geometric shape, e.g., spheres, hemispheres, cubes, rhombohedra, ellipsoids, and doubly curved surfaces, and are not limited to mere conical shapes as illustrated in FIGS. 2 and 3. Furthermore, even though the mixture of a silicone epoxy resin and a conductivity enhancing agent is described above as a mold release agent, it is more generally a release agent, and may have applicability outside the field of mold release agents, e.g., as a coating on tools that are used to manipulate electrically sensitive materials or just plain sticky materials that are not electrically sensitive. The release agent can also be used as a coating for walkways, or general construction materials where the physical properties would be useful in, for example, an anti-graffiti coating having improved interaction with radio waves or light due to the modified dielectric constant of the film.

Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

We claim:

1. A mold release agent precursor for making a mold releasing agent, the mold release agent precursor having a total weight and comprising:
a polymer resin; and
a conductivity enhancing agent dispersed in the polymer resin, the conductivity enhancing agent being present in effective amount and dispersion to impart a surface resistivity of less than 1×10¹² ohms/in² in the mold release agent upon curing of the polymer resin.

2. The mold release agent precursor of claim 1, wherein the conductivity enhancing agent is mixed substantially homogeneously in the polymer resin.

3. The mold release agent precursor of claim 1, wherein the polymer resin comprises a curable silicone epoxy resin.

4. The mold release agent precursor of claim 3, wherein the curable silicone epoxy resin comprises a water-based resin.

5. The mold release agent precursor of claim 3, wherein:
the curable silicone epoxy resin comprises a mixture of a silicone resin and an epoxy resin; and
a ratio of the silicone resin to the epoxy resin ranges from about 1:4 to about 4:1 parts by weight.

6. The mold release agent precursor of claim 3, wherein the curable silicone epoxy resin is formed of sufficient amounts of silicone and epoxy resins to impart, upon curing of the silicone epoxy resin, a non-stick release adhesion of about 20 g/in by TAPPI 502; an ultimate contact angle (water) of 85 degrees to 99 degrees by goniometer; and a pencil hardness of up to 2H to 3H (scratch) and up to 3H to 4H (gouge) by ASTM D3363.

7. The mold release agent precursor of claim 3, wherein the conductivity enhancing agent comprises carbon particles.

8. The mold release agent precursor of claim 7, wherein carbon particles comprise carbon black.

9. The mold release agent precursor of claim 8, wherein the carbon black comprises furnace-formed carbon black.

10. The mold release agent precursor of claim 8, wherein the carbon black is present in the mold release agent precursor in an amount greater than two weight percent of the total weight of the mold release agent precursor.

11. The mold release agent precursor of claim 8, wherein the carbon black is present in the mold release agent precursor in an amount greater than three weight percent of the total weight of the mold release agent precursor.

12. The mold release agent precursor of claim 8, wherein the carbon black is present in the mold release agent precursor in an amount in a range of three weight percent to seven weight percent of the total weight of the mold release agent precursor.

13. The mold release agent precursor of claim 7, wherein the conductive carbon particles are present in the mold release agent precursor in an amount greater than two weight percent of the total weight of the mold release agent precursor.

14. The mold release agent precursor of claim 7, wherein the conductive carbon particles are present in the mold release agent precursor in an amount greater than three weight percent of the total weight of the mold release agent precursor.

15. The mold release agent precursor of claim 7, wherein the conductive carbon particles are present in the mold release agent precursor in an amount in a range from three weight percent to seven weight percent of the total weight of the mold release agent precursor.

16. The mold release agent precursor of claim 1, wherein the mold release agent precursor is in an uncured state.

17. The mold release agent precursor of claim 1, further comprising a gas in a mixture with the mold release agent to form a mist.

18. The mold release agent precursor of claim 1, wherein the surface resistivity is in a range of 1.0×10⁶ ohms/in² to 1×10¹² ohms/in².

19. A method for making a mold release agent, the method comprising:
mixing a conductivity enhancing agent with a polymer resin to form a mold release agent precursor, and curing the mold release agent precursor to form the mold release agent having a total weight, the mold release agent having a surface resistivity less than 1×10¹² ohms/in².

20. A method of providing a mold with a mold release agent, the method comprising:
providing the mold to present a surface ready for receipt of a curable mold release agent precursor;
coating the surface of the mold with the curable mold release agent precursor that comprises a conductivity enhancing agent mixed with a polymer resin; and
curing the mold release agent precursor to obtain the mold release agent, the mold release agent having a total weight and a surface resistivity of less than about 1×10¹² ohms/in².

21. The method of claim 20, wherein the conductivity enhancing agent is substantially homogeneous mixed in the polymer resin.

22. The method of claim 20, wherein the polymer resin comprises a silicone epoxy resin.

23. The method of claim 22 wherein the silicone epoxy resin comprises a water-based resin.

24. The method of claim 22, wherein the silicone epoxy resin comprises a silicone component and an epoxy component in a ratio ranging from about 1:4 to about 4:1 parts by weight.

25. The method of claim 22, wherein the mold release agent has a non-stick release adhesion of about 20 g/in by TAPPI 502; an ultimate contact angle (water) of 85 degrees to 99 degrees by goniometer; and a pencil hardness of up to 2H to 3H (scratch) and up to 3H to 4H (gouge) by ASTM D3363.

26. The method of claim 20, wherein the conductivity enhancing agent comprises conductive carbon particles.

27. The method of claim 26, wherein the conductive carbon particles comprise a conductive form of carbon black.

28. The method of claim 27, wherein the conductive form of carbon black comprises furnace-formed carbon black.

29. The method of claim 27, wherein the carbon black is present in the polymer resin in an amount greater than two weight percent carbon black based on the total weight of the mold release agent.

30. The method of claim 29, wherein the carbon black is present in the polymer resin in an amount greater than three weight percent carbon black based on the total weight of the mold release agent.

31. The method of claim 27, wherein the carbon black is present in the polymer resin in an amount ranging from three weight percent to seven weight percent carbon black based on the total weight of the mold release agent.

32. The method of claim 26, wherein the conductive carbon particles are present in the polymer resin in an amount greater than two weight percent carbon based on the total weight of the mold release agent.

33. The method of claim 26, wherein the conductive carbon particles are present in the polymer resin in an amount greater three weight percent carbon based on the total weight of the mold release agent.

34. The method of claim 26, wherein the conductive carbon particles are in the polymer resin in an amount in a range from three weight percent to seven weight percent carbon based on the total weight of the mold release agent.

35. The method according to claim 20, wherein said coating comprises spray coating the mold release agent precursor onto the surface of the mold.

36. A coated mold comprising:
a mold presenting a contact surface shaped for conformably shaping mold contents placed into contact with the mold; and
a mold release agent covering the contact surface, the mold release agent including a cured composition comprising conductive carbon particles dispersed in a non-stick polymer in effective amounts to impart a surface resistivity less than 1×10¹² ohms/in².

37. The mold of claim 36, wherein the mold release agent comprises a substantially homogeneous mixture of the conductivity enhancing agent and the non-stick polymer.

38. The mold of claim 36, wherein the non-stick polymer is formed from a silicone epoxy resin.

39. The mold of claim 38, wherein the silicone epoxy resin comprises a three component grafted silicone epoxy resin.

40. The mold of claim 38, wherein the silicone epoxy resin comprises a silicone component and an epoxy component in a ratio ranging from 1:4 to 4:1 parts by weight of the silicone component to the epoxy component.

41. The mold of claim 38, wherein the mold release agent has a non-stick release adhesion of about 20 g/in by TAPPI 502; an ultimate contact angle (water) of 85 degrees to 99 degrees by goniometer; and a pencil hardness of up to 2H to 3H (scratch) and up to 3H to 4H (gouge) by ASTM D3363.

42. The mold of claim 38, wherein the conductivity enhancing agent comprises carbon particles.

43. The mold of claim 42, wherein carbon particles comprise carbon black.

44. The mold of claim 43, wherein the carbon black comprises furnace-formed carbon black.

45. The mold of claim 43, wherein the carbon black constitutes more than two percent by weight of the mold release agent.

46. The mold of claim 43, wherein the carbon black constitutes more than three percent by weight of the mold release agent.

47. The mold of claim 43, wherein the carbon black is present in the mold release agent in an amount in a range from three percent to seven percent by weight of the mold release agent.

48. The mold of claim 42, wherein the carbon particles are present in the mold release agent in an amount greater than two weight percent of the mold release agent.

49. The mold of claim 42, wherein the carbon particles are present in the mold release agent in an amount greater than three weight percent of the mold release agent.

50. The mold of claim 42, wherein the carbon particles are present in the mold release agent in an amount ranging from three weight percent to seven weight percent of the mold release agent.

51. The mold of claim 36, wherein the mold release agent has a surface resistivity ranging from 1×10⁶ ohms/in² to 1×10¹² ohms/in².

52. A method of shaping materials using
a mold having a cavity presenting a contact surface shaped for comformably shaping contents placed into the cavity, and
a mold release agent covering the contact surface, the method comprising:
placing contents into the mold for shaping in contact with the mold release agent, the mold release agent being formed from a composition comprising conductive carbon particles mixed to a dispersion with a silicone epoxy resin in effective amounts to impart, upon curing of the silicone epoxy resin, a surface resistivity less than 1×10¹² ohms/in² to the mold release agent;
molding the contents into a predetermined shape; and
removing the contents from the mold.
